(19) United States
(12) Patent Application Publication
(10) Pub. No.: US 2026/0157340 A1
(43) Pub. Date: Jun. 11, 2026

(54) ANIMAL TRAINING PAD HAVING URINE-REPELLANT AREAS BORDERED BY URINE-COLLECTION CHANNELS

(71) Applicant: FOUR PAWS PRODUCTS, LTD., Neptune City, NJ (US)

(72) Inventors: Glen S. AXELROD, Colts Neck, NJ (US); Ajay GAJRIA, Monmouth Junction, NJ (US); Mary Louise FETTER, Ocean, NJ (US)

(21) Appl. No.: 19/179,082

(22) Filed: Apr. 15, 2025

Related U.S. Application Data
(60) Provisional application No. 63/634,702, filed on Apr. 16, 2024.

(51) Int. Cl. A01K 1/015

(52) U.S. Cl. CPC A01K 1/01577

(57) ABSTRACT

An animal training pad comprising a top layer; a urine-impermeable base layer; at least one internal layer disposed between the top layer and the urine-impermeable base layer, wherein the at least one internal layer comprises an absorbent layer; wherein the top layer has at least one urine-repellant area bordered by at least one urine-collection channel; and wherein the at least one urine-collection channel comprises an opening formed in the top layer which exposes the at least one internal layer to urine when disposed on the at least one urine-repellant area of the top layer.

### CROSS-REFERENCE TO RELATED APPLICATIONS

This non-provisional patent application claims the benefit of the filing date of U.S. provisional patent application serial no. 63/634,702 filed April 16, 2024, the entire disclosure of which is incorporated by reference, to an extent consistent therewith.

### FIELD

The present disclosure generally relates to an animal training pad. More specifically, the present disclosure relates to an animal training pad comprising at least one or a plurality of internal layers disposed between a liquid-impermeable base layer, particularly a urine-impermeable base layer, and a top layer having at least one or a plurality of urine liquid-repellant areas, particularly urine-repellant areas, bordered by at least one or a plurality of urine-collection channels.

### BACKGROUND

Pet owners often use animal training pads to protect their indoor surfaces from animal urine and/or defecation by teaching pets to relieve themselves on the training pads when indoors. These training pads often have a urine-impermeable base layer, a urine-permeable top layer and at least one or a plurality of internal layers, such as at least one or a plurality of absorbent layers, disposed between the top layer and the base layer. These training pads are configured so that the urine-impermeable base layer rests on the indoor surface and the urine-permeable top layer is accessible to the animal for urination or defecation. When the pet relieves themself on these training pads, the urine passes through the urine-permeable top layer, is absorbed into the internal (intermediate) absorbent layer(s) and prevented by the urine-impermeable base layer from contacting the indoor surface on which it rests.

However, because the top layer is urine-permeable and hence open to flow there through to the absorbent layer(s), the urine-soaked absorbent portion of the training pad is open to the surrounding environment or is only separated from the surrounding environment by the urine-permeable top layer. In such a situation, the urine-permeable top layer and the urine-soaked absorbent layer(s) are more likely to emit foul odors and/or cause a pet walking over the training pad to get urine on its paws and track that urine onto the surrounding indoor surfaces. While some training pads may include some configuration of channels on the urine-permeable top surface/layer to direct the flow of the urine through the channels, the urine-soaked absorbent portion of the pad is still fully exposed to the external environment through the urine-permeable top layer.

Therefore, there is a need among pet owners for a training pad with a top layer comprising urine-repellant areas bordered by urine-collection channels, a base/bottom urine-impermeable layer, and at least one or a plurality of internal layers, wherein at least one internal layer is absorbent layer, such that the urine deposited on the top surface is directed to flow off the urine-repellant areas and into the urine-collection channels through which the urine will be absorbed further into the absorbent internal layer(s). Thus, the portion of the internal absorbent layer below the urine-repellant areas on the top layer, that absorbs the urine through the urine-collection channels will be separated from the external environment by the urine-repellant areas and less apt to emit foul odors and inhibit urine from being tracked by the pet.

### SUMMARY

An animal training pad comprising a top layer having at least one or a plurality of urine-repellant areas bounded by at least one or a plurality of urine-collection channels, a urine-impermeable base layer and at least one or a plurality of internal layers disposed between the top and base layer, wherein at least one of the internal layers is an absorbent layer.

In a least one embodiment, an animal training pad is provided, comprising a top layer; a urine-impermeable base layer; at least one internal layer disposed between the top layer and the urine-impermeable base layer, wherein the at least one internal layer comprises an absorbent layer; wherein the top layer has at least one urine-repellant area bordered by at least one urine-collection channel; and wherein the at least one urine-collection channel comprises an opening formed in the top layer which exposes the at least one internal layer to urine when disposed on the at least one urine-repellant area of the top layer.

In a least one embodiment, the top layer having the at least one urine-repellant area bordered by the at least one urine-collection channel further comprises the top layer having a plurality of urine-repellant areas bordered by a plurality of urine-collection channels.

In a least one embodiment, the plurality of urine-collection channels completely surround the plurality of urine-repellant areas.

In a least one embodiment, the plurality of urine-repellant areas are completely isolated from one another by the plurality of urine-collection channels.

In a least one embodiment, the plurality of urine-collection channels comprise a plurality of substantially parallel urine-collection channels and/or a plurality of substantially perpendicular urine-collection channels.

In a least one embodiment, the plurality of urine-collection channels comprise the plurality of substantially parallel urine-collection channels and the plurality of substantially perpendicular urine-collection channels.

In a least one embodiment, the plurality of substantially parallel urine-collection channels and the plurality of substantially perpendicular urine-collection channels intersect.

In a least one embodiment, the at least one urine-collection channel has a depth which extends into the at least one internal layer.

In a least one embodiment, the at least one internal layer has a thickness and the at least one urine-collection channel extends into the thickness of the at least one internal layer in a range of 25% to 95% of the thickness of the at least one internal layer.

In a least one embodiment, the at least one urine-collection channel has a width in a range of 0.5 inch to 3 inches.

In a least one embodiment, the at least one urine-collection channel is U-shaped, V-shaped or semi-circular shaped.

In a least one embodiment, the at least one urine-collection channel has an arcuate bottom, planar bottom or pointed bottom.

In a least one embodiment, the top layer, inclusive of the at least one urine-repellant area, slopes towards the at least one urine-collection channel.

In a least one embodiment, the top layer, inclusive of the at least one urine-repellant area, is convex.

In a least one embodiment, the at least one urine-repellant area repels at least 75% of urine disposed thereon from being absorbed by the top layer.

In a least one embodiment, the at least one urine-repellant area is formed of a hydrophobic polymer.

In a least one embodiment, the absorbent layer is formed of a superabsorbent polymer.

In a least one embodiment, the at least one internal layer further comprises at least one of an attractant layer, a scented layer, or scent masking layer.

In a least one embodiment, a method of forming a pet training pad is provided, the method comprising forming a layered structure having a top layer, a urine-impermeable base layer and at least one internal layer disposed between the top layer and the urine-impermeable base layer, wherein the at least one internal layer comprises an absorbent layer and wherein the top layer has at least one urine-repellant area; and forming at least one urine-collection channel in the layered structure by removing at least a portion of the top layer to provide an opening in the top layer which exposes the at least one internal layer beneath the removed portion of the top layer to urine when disposed on the at least one urine-repellant area of the top layer; wherein the at least one urine-repellant area is bordered by at least one urine-collection channel.

In a least one embodiment, the method further comprises forming the at least one urine-collection channel in the layered structure by removing a portion of the at least one internal layer beneath the removed portion of the top layer.

### BRIEF DESCRIPTION OF THE DRAWINGS

Features and advantages of this disclosure will become more apparent as the following detailed description proceeds, and upon reference to the drawings, wherein like numerals designate like parts, and in which:

FIG. 1 depicts a top side (plan) view of an embodiment of an animal training pad according to the present disclosure;

FIG. 2 depicts a cross-sectional view of the embodiment of FIG. 1;

FIG. 3 depicts the cross-sectional view of FIG. 2 after the animal training pad has been soiled with urine;

FIG. 4 depicts a cross-section view of another embodiment of the present animal training pad according to the present disclosure;

FIG. 5 depicts the various layers, including optional layers, of the animal training pad; and

FIG. 6A depicts a V-shaped urine-collection channel according to the present disclosure;

FIG. 6B depicts a rectangular-shaped urine-collection channel according to the present disclosure; and

FIG. 6C depicts a square-shaped urine-collection channel according to the present disclosure;

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

As noted in the background, animal training pads are currently known. Although such training pads can be effective, they are configured so that the top surface/layer is urine-permeable, such that when the animal uses the training pad, the urine-soaked absorbent material layer is only separated by the urine-permeable top layer from the external environment. In such a configuration, there is a risk that the odor will easily escape from the urine-permeable top layer or that a pet will step on the soiled pad where the pressure of their paw could cause the urine to squeeze out of the absorbent material layer and through the top urine-permeable layer.

With the foregoing in mind, referring to the figures generally, the present disclosure generally relates to an animal training pad 10 having a top (outer exposed) layer 12 comprised of at least one or a plurality of liquid-repellant areas 14, and more particularly urine-repellant areas 14, defined by urine-collection (absorbent) channels 16, a liquid-impermeable base (bottom) layer 22, and more particularly urine-impermeable base layer 22, and at least one or a plurality of internal layers 20 disposed between the top layer 12 and base layer 22.

The urine-repellant areas 14 of the animal training pad 10 may be comprised of a hydrophobic polymer. For example, top layer 12 may be formed of a non-woven fiber mat with the extruded fibers formed of a hydrophobic polymer, or a hydrophobic polymer disposed on the non-woven fibers.

The urine-impermeable base layer 22 may be comprised of a single-layer or multi-layer film wherein at least one of the layers is a polyolefin, particularly polyethylene.

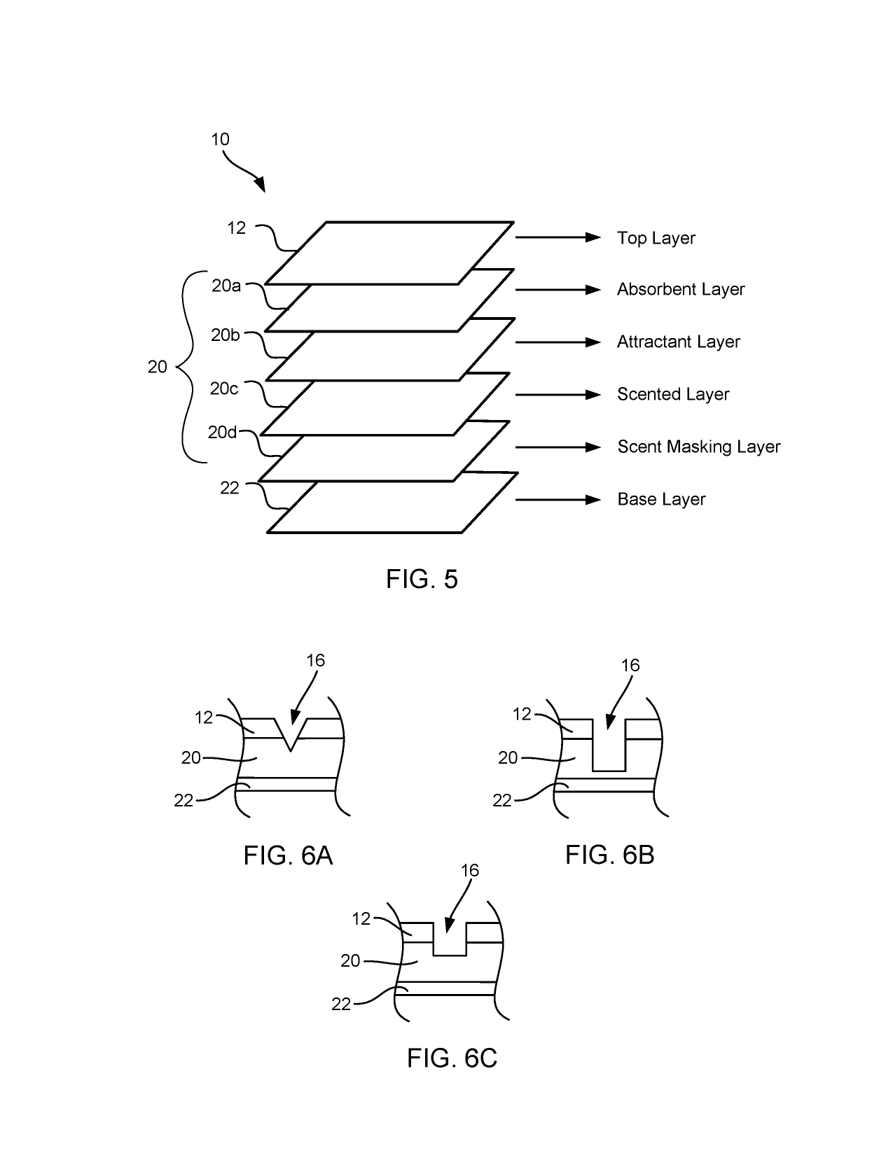

The at least one or plurality of internal layers 20 may include at least one absorbent layer 20a, which may directly underlie the top layer 12 and be closest thereto. In another embodiment, the at least one or plurality of internal layers 20a may preferably include at least one or a plurality of an absorbent layer 20a, an attractant layer 20b, scented layer 20c, and/or a scent masking layer 20d, as shown in FIG. 5.

Reference to a urine-repellant area 14 is reference to the feature that at least or greater than 75% of the liquid (e.g. urine) by weight will be repelled (as opposed to or against being absorbed through top layer 12) and be directed into the urine-collection channels 16. More particularly at least or greater than 85% of the liquid (e.g. urine) by weight will be repelled (as opposed to absorbed through top layer 12) and be directed into the urine-collection channels 16. Even more particularly at least or greater than 95% of the liquid (e.g. urine) by weight will be repelled (as opposed to absorbed through top layer 12) and be directed into the urine-collection channels 16. Even more particularly at least or greater than 98% of the liquid (e.g. urine) by weight will be repelled (as opposed to absorbed through top layer 12) and be directed into the urine-collection channels 16. Even more particularly, 100% of the liquid (e.g. urine) by weight will be repelled (as opposed to absorbed through top layer 12) and be directed into the urine-collection channels 16.

More preferably, the urine-repellant area 14 is reference to an area that preferably absorbs (transmits through) less than or equal to 5.0% by weight of urine over a 24 hour period, more preferably less than or equal to 4.0% by weight of urine over a 24 hour period, or less than or equal to 3.0% by weight of urine over a 24 hour period, or less than or equal to 2.0% by weight of urine over a 24 hour period, or less than or equal to 1.0% by weight of urine over a 24 hour period.

The at least one or plurality of absorbent internal layers 20, and more particularly the absorbent layer 20a, preferably comprise a superabsorbent polymer. More specifically, the superabsorbent polymer may have, for example, a retention absorbency in a range of 30 g/g to 45 g/g, an absorption capacity in a range of 55 g/g to 65 g/g (as measured in a 0.9% NaCl aqueous solution), an absorption rate (e.g., a quantity of time to absorb 50, 100, or 150 milliliters of liquid such as a 0.9% NaCl aqueous solution) in a range of 15 seconds to 40 seconds, a moisture content in a range of 4% to 9%, a measure of residual acrylic acid monomers in a range of 15 parts-per-million (ppm) to 25 ppm, and a bulk density in a range of 0.6 g/ml to 0.85 g/ml.

By way of a further example, the superabsorbent polymer may have a retention absorbency of 41 g/g, an absorption capacity of 60 g/g (as measured in a 0.9% NaCl aqueous solution), an absorptive rate of 29 seconds, a moisture content of 7.4%, a measure of residual acrylic acid monomers of 22 ppm, and a bulk density of 0.74 g/ml. By way of still further example, the superabsorbent polymer may have a retention rate of 40 g/g, an absorption capacity of 60 g/g (as measured in a 0.9% NaCl aqueous solution), an absorption rate of 30 seconds, a moisture content of 7.2%, a measure of residual acrylic acid monomers of 18 ppm, and a bulk density of 0.74 g/ml. Particle sizes of the superabsorbent polymer may measure less than 850 microns (µm). For example, between 80% and 90% of the particles may have a particle size measuring in a range of 180 µm to 500 µm.

An attractant internal layer 20b may include at least one or a plurality of attractants to encourage a pet to approach the training pad when there is a need to relieve themselves. For example, the attractant may include at least one or a plurality of pheromones configured to encourage the pet to urinate on the training pad. A scented internal layer 20c may preferably provide a scent capable of attracting the pet and/or capable of masking odors that occur after use. A scent masking internal layer 20d may preferably cover-up odors that occur after use and reduce the amount of scent detectable by the owner. Optionally, one may use a fragrance.

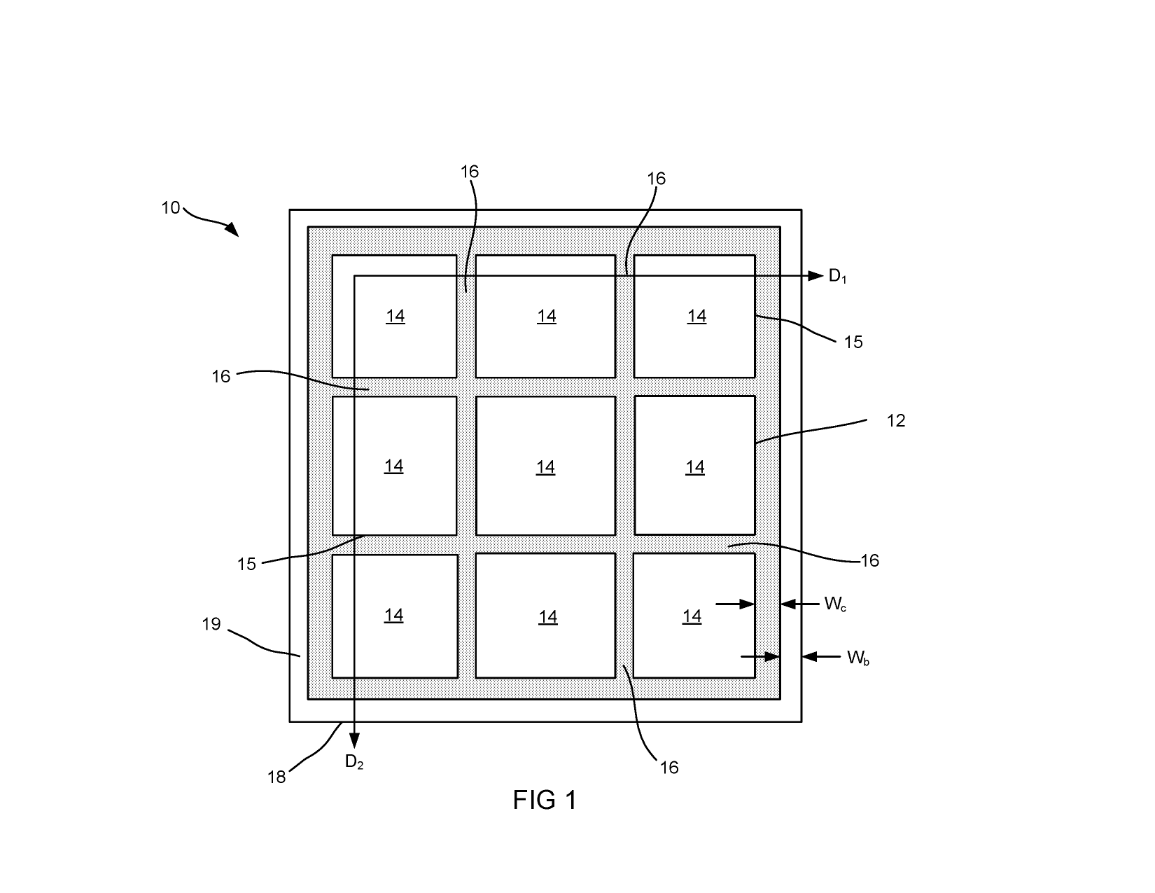

FIG. 1 depicts a top side (plan) view of an embodiment of a preferred animal training pad 10 according to the present disclosure. The animal training pad 10 is shown to include a top layer 12 comprising at least one or a plurality of urine-repellant areas 14 bordered by at least one or a plurality of urine-collection channels 16, which comprise elongated openings 17 formed in the top layer 12, which expose the at least one internal layers 20 there beneath to urine when disposed on the urine-repellant areas 14 of the top layer 12, particularly to absorbent layer 20a. Such urine-collection channels 16 bordering the at least one or plurality of urine-repellant areas 14 may be configured as multiple intersecting channels or multiple disconnected channels.

As shown, the urine-collection channels 16 are all linear. As shown, some of the urine-collection channels 16 extend substantially parallel with each other (e.g. within 10 degrees of being parallel inclusive of being parallel), and some of the urine-collection channels 16 extend substantially perpendicular with each other (e.g. within 10 degrees of being perpendicular inclusive of being perpendicular). As shown, the urine-collection channels 16 intersect such that all the urine-collection channels 16 are interconnected.

As shown, the top layer 12 may preferably comprise a quantity of isolated urine-repellant areas 14, which may be in the range of 1 to 200, including all values and increments therein, wherein each isolated urine-repellant area 14 is bordered by at least one or a plurality of urine-collection channels 16, and more particularly completely bordered (surrounded) by the plurality of urine-collection channels 16. More preferably, one may employ 4 to 25 urine-repellant areas 14.

The animal training pad 10 may preferably have at least one or a plurality of perimeter edges 18 and have a geometric shape (e.g., square, rectangle, circle, triangle, quadrilateral, hexagon, polygon, etc.). The length of the at least one or a plurality of edges 18 may be equal or different. Preferably, the length of each of the at least one or a plurality of edges 18 is in the range of 1 ft and 4 ft, more preferably in the range of 1.5 ft and 3.5 ft.

Further, the animal training pad may have a perimeter border 19 adjacent to and defining the at least one or a plurality of edges 18, which may be non-absorbent. The perimeter border 19 may be continuous loop/track around the perimeter of the training pad 10, and have a width W_{b} that extends inward within a portion of the animal training pad 10 from the at least one or a plurality of edges 18. The width W_{b} of said non-absorbent border 19 may preferably be in the range of 0.5 in. and 4 in., more preferably in the range of 1 in. and 2 in.

The at least one or plurality of urine-repellant areas 14 may have at least one or a plurality of edges 15 and have a geometric shape (e.g., square, rectangle, triangle, quadrilateral hexagon, polygon, etc.). The length of the at least one or a plurality of edges 15 of the at least one or plurality of urine-repellant 14 areas may be equal or different. Preferably the length of each of the at least one or a plurality of edges 15 of the at least one or plurality of urine-repellant areas 14 is in the range of 2 in. and 24 in., more preferably between 6 in. and 12 in.

The urine-collection channels may have a variable or constant width W_{c} where the width is preferably in the range of 0.25 inch and 3 inches, more preferably 0.5 inch and 3 inches, even more preferably in the range of 1 inch and 1.5 inches. The ratio of the surface area of the at least one or a plurality of urine-repellant areas 14 to the surface area of the urine-collection channels 16, in the plan view of the pad 10 is preferably 5:4. Once the layers 12, 20, 22 are laminated or otherwise joined/assembled in the layered structure, the channels 16 may be formed by removing the corresponding portion(s) of the top layer 12 and, optionally, corresponding portion(s) of the at least one or a plurality of internal layers 20 there beneath, of the training pad 10, such as by cutting, which would otherwise occupy the volume of the urine-collection channels 16.

The at least one or plurality of urine-repellant areas 14 may preferably be arranged on the top layer in a grid. For example, the at least one or plurality of urine-repellant areas 14 may be arranged in a 2 by 2 grid, 3 by 3 grid, 4 by 4 grid, 5 by 5 grid, or a 6 by 6 grid. More preferably, the at least one or plurality of urine-repellant areas 14 may be arranged in a grid comprising a first row having a first quantity of urine-repellant areas 14 in the range of 2 to 10 extending along a first edge 18 of the top layer 12/pad 10 in a first direction D₁ and a second quantity of urine-repellant areas 14 in the range of 2 to 10 extending from each of the urine-repellant areas 14 of the first row in a second direction D₂ (shown perpendicular to the first direction D₁) of a second edge 18 of the top layer 12/pad 10. In FIG. 1, a 3 by 3 grid is shown.

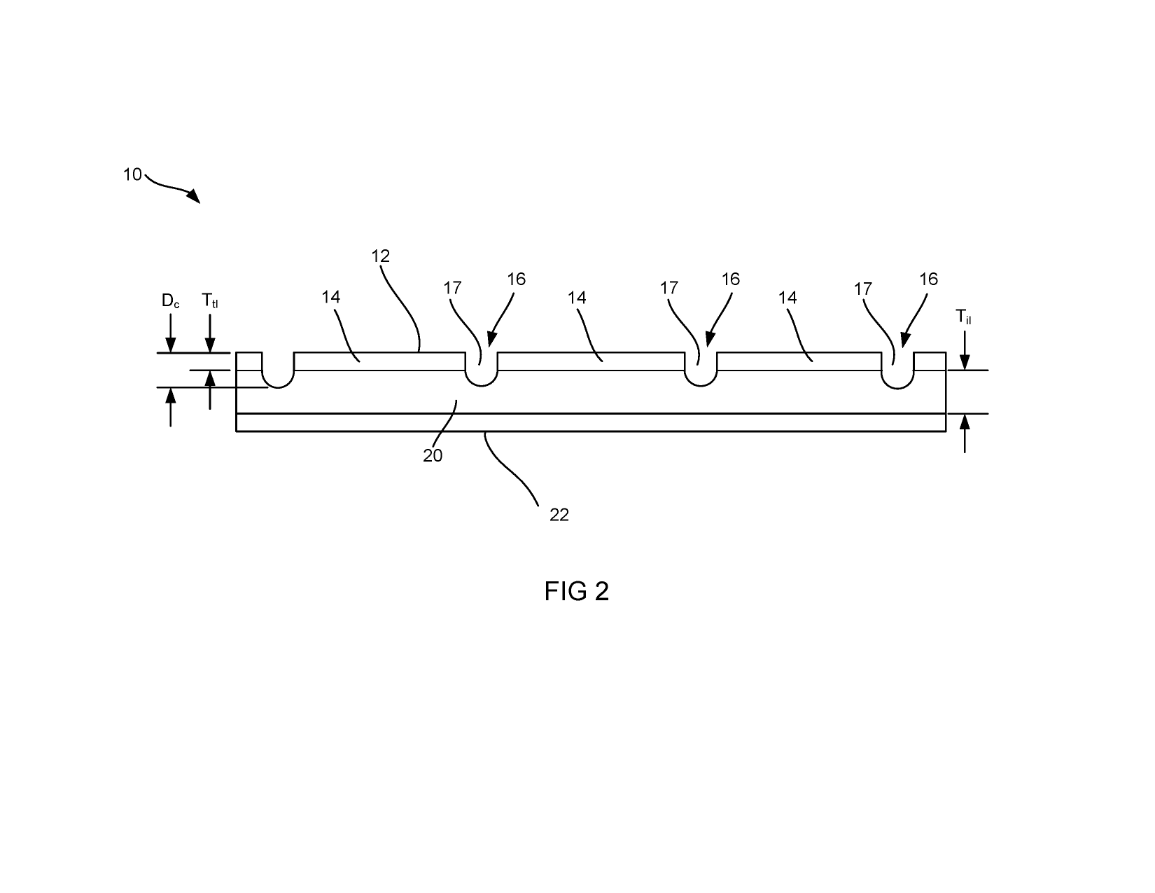

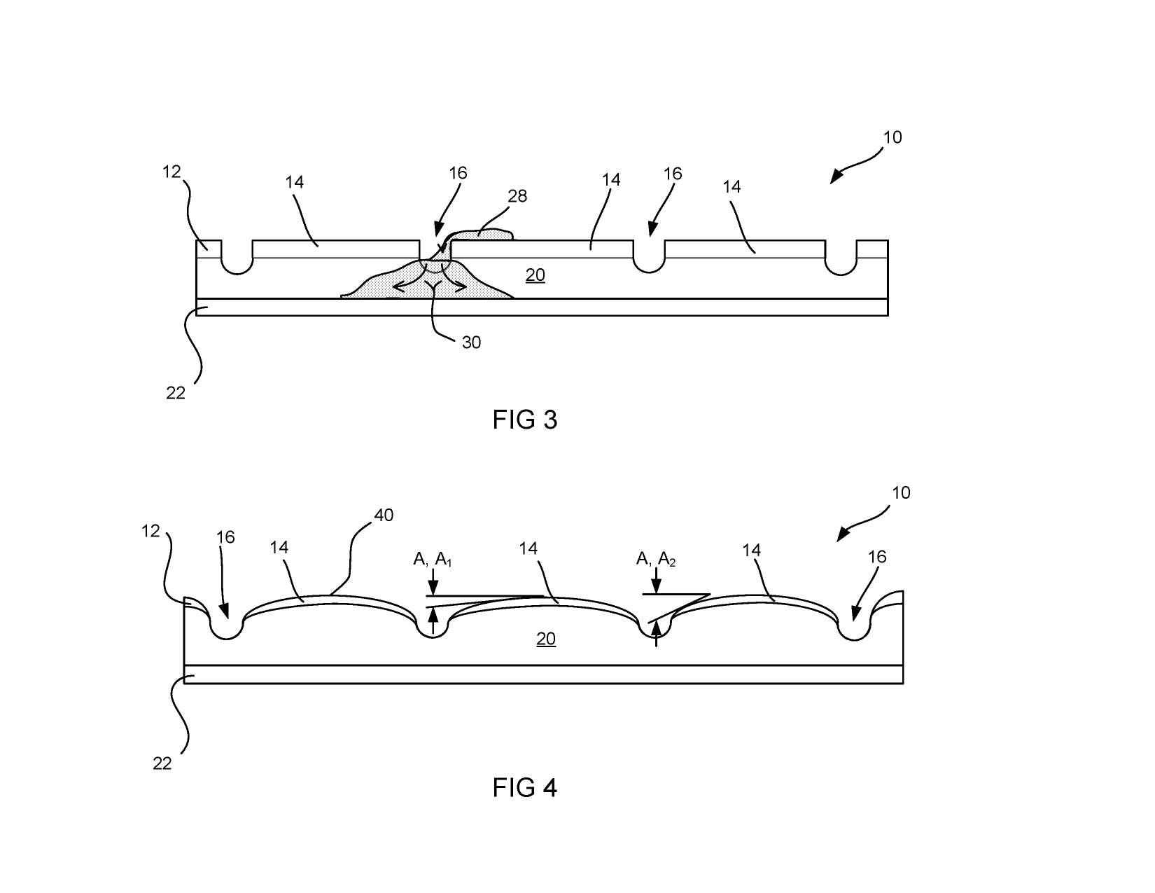

FIG. 2 depicts a cross-sectional view of the embodiment of the preferred animal training pad 10 in FIG. 1. As shown in FIG. 2, the animal training pad 10 has a top layer 12 comprising at least one or a plurality of urine-repellant areas 14 bordered by urine-collection channels 16, at least one or a plurality of internal layers 20, and a urine-impermeable base layer 22. The urine-collection channels 16 may preferably have a cross-sectional geometry/shape such as a “U”-shaped channel (as shown in FIGS. 2-3), “V”-shaped (FIG. 6A having a pointed bottom) channel, rectangular-shaped (planar sides and bottom, with side length longer than bottom) channel (FIG. 6B), square-shaped planar sides and bottom, with sides and bottom of equal length) channel (FIG. 6C), polygon, etc. More preferably, as shown in FIGS. 2-4, the cross-sectional geometry of the urine-collection channels 16 is arcuate, and more particular semi-circular, at the bottom of the channels 16.

The urine-collection channels 16 is shown to have a channel depth D c that extends through the top layer 12, and may extend through the at least one or a plurality internal layers 20. The channel depth D_{c} of the urine-collection channels 16 may preferably be in the range of 0.1 mm to 1 mm, more preferably in the range of 0.35 mm to 0.85 mm. The urine-repellant areas 14 of the top layer 12 of the animal training pad 10 may have a thickness Tₜₗ preferably in the range of 0.1 mm to 1 mm (corresponding to the channel depth D_{c}), more preferably in the range of 0.35 mm to 0.85 mm (corresponding to the channel depth D_{c}). In other words, the depth D_{c} of the urine-collection channels 16 will be at least equal to at least the thickness T tl of the urine-repellant areas 14 of the top layer 12 of the animal training pad 10.

As shown, the depth D_{c} of the urine-collection channels 16 preferably extends partially into and through the thickness Tᵢₗ of the internal layer(s) 20, and do not extend completely through the internal layer(s) 20 as to not damage the underlying urine-impermeable base layer 22.

The depth D_{c} of the urine-collection channels 16 may extend into the thickness Tᵢₗ of the internal layer(s) 20 in a range between 25% to 95% into the thickness Tᵢₗ of the internal layer(s) 20, particularly the absorbent layer 20a. More particularly, the depth D_{c} of the urine-collection channels 16 may extend into the thickness Tᵢₗ of the internal layer(s) 20 in a range between 50% to 95% into the thickness Tᵢₗ of the internal layer(s) 20, particularly the absorbent layer 20a. Even more particularly, the depth D_{c} of the urine-collection channels 16 may extend into the thickness Tᵢₗ of the internal layer(s) 20 in a range between 75% to 95% into the thickness Tᵢₗ of the internal layer(s) 20, particularly the absorbent layer 20a.

FIG. 3 depicts the same cross-sectional view of the animal training pad of FIG. 1 as shown in FIG. 2 and further depicts an example of how urine 28 deposited on the urine-repellant areas 14 by a pet may preferably flow and be absorbed into the animal training pad 10 through the urine-collection channels 16. The preferred flow 30 is represented by arrows in FIG. 3 such that the urine 28 deposited on the urine-repellant areas 14 may flow into the urine-collection channel 16 and be absorbed therein and further absorbed into the at least one or a plurality of internal layers 20 below the at least one or a plurality of urine-repellant areas 14. As shown, the urine 28 does not flow thorough the urine-repellant areas 14 of the top layer 12, but rather only through the channels 16 formed in the top layer 12.

FIG. 4 depicts a cross-sectional view of another embodiment of the animal training pad 10 according to the present disclosure, wherein the urine-repellant area(s) 14 and/or the internal layer(s) 20 may provide a sloping (convex) top surface 40 of the top layer 12 that may slope towards the urine-collection channels 16. Preferably, the sloping top surface 40/ top layer 12 is downwardly sloped toward the urine-collection channels 16 at an angle A in the range of 1° to 40° as measured relative to horizonal. Accordingly, the sloping top surface 40/ top layer 12 may be downwardly sloping toward the urine-collection channels 16 at an angel A in any range of 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39° or 40°. As shown, the angle A may increase in magnitude, e.g. from A₁ to A₂, as the distance along the sloping top surface 40/ top layer 12 decreases towards the urine-collection channels 16.

While preferred embodiments of the present disclosure have been described, it should be understood that various changes, adaptations and modifications can be made therein without departing from the spirit of the disclosure and the scope of the appended claims. The scope of the disclosure should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

### LIST OF REFERENCE CHARACTERS

10 animal training pad

12 top layer

14 liquid urine-repellant areas

15 liquid urine-repellant area edge

16 liquid urine-collection channels

18 perimeter edge

19 perimeter border

20 internal layers

20a absorbent internal layer

20b attractant internal layer

20c scented internal layer

20d scented masking internal layer

22 base layer

28 urine

30 urine flow

40 top surface

A angle (including A₁ and A₂)

D₁ first direction

D₂ second direction

D_{c} depth of channel

W_{b} width of border

W_{c} width of channel

Tᵢₗ thickness of the internal layer(s)

Tₜₗ thickness of top layer

What is claimed is:

1. An animal training pad comprising:
a top layer;
a urine-impermeable base layer;
at least one internal layer disposed between the top layer and the urine-impermeable base layer, wherein the at least one internal layer comprises an absorbent layer;
wherein the top layer has at least one urine-repellant area bordered by at least one urine-collection channel; and
wherein the at least one urine-collection channel comprises an opening formed in the top layer which exposes the at least one internal layer to urine when disposed on the at least one urine-repellant area of the top layer.

2. The animal training pad of claim 1, wherein the top layer having the at least one urine-repellant area bordered by the at least one urine-collection channel further comprises the top layer having a plurality of urine-repellant areas bordered by a plurality of urine-collection channels.

3. The animal training pad of claim 2, wherein the plurality of urine-collection channels completely surround the plurality of urine-repellant areas.

4. The animal training pad of claim 2, wherein the plurality of urine-repellant areas are completely isolated from one another by the plurality of urine-collection channels.

5. The animal training pad of claim 2, wherein the plurality of urine-collection channels comprise a plurality of substantially parallel urine-collection channels and/or a plurality of substantially perpendicular urine-collection channels.

6. The animal training pad of claim 5, wherein the plurality of urine-collection channels comprise the plurality of substantially parallel urine-collection channels and the plurality of substantially perpendicular urine-collection channels.

7. The animal training pad of claim 6, wherein the plurality of substantially parallel urine-collection channels and the plurality of substantially perpendicular urine-collection channels intersect.

8. The animal training pad of claim 1, wherein the at least one urine-collection channel has a depth which extends into the at least one internal layer.

9. The animal training pad of claim 8, wherein the at least one internal layer has a thickness and the at least one urine-collection channel extends into the thickness of the at least one internal layer in a range of 25% to 95% of the thickness of the at least one internal layer.

10. The animal training pad of claim 1, wherein the at least one urine-collection channel has a width in a range of 0.5 inch to 3 inches.

11. The animal training pad of claim 1, wherein the at least one urine-collection channel is U-shaped, V-shaped or semi-circular shaped.

12. The animal training pad of claim 1, wherein the at least one urine-collection channel has an arcuate bottom, planar bottom or pointed bottom.

13. The animal training pad of claim 1, wherein the top layer, inclusive of the at least one urine-repellant area, slopes towards the at least one urine-collection channel.

14. The animal training pad of claim 1, wherein the top layer, inclusive of the at least one urine-repellant area, is convex.

15. The animal training pad of claim 1, wherein the at least one urine-repellant area repels at least 75% of urine disposed thereon from being absorbed by the top layer.

16. The animal training pad of claim 1, wherein the at least one urine-repellant area is formed of a hydrophobic polymer.

17. The animal training pad of claim 1, wherein the absorbent layer is formed of a superabsorbent polymer.

18. The animal training pad of claim 1, wherein the at least one internal layer further comprises at least one of an attractant layer, a scented layer, or scent masking layer.

19. A method of forming a pet training pad, the method comprising:
forming a layered structure having a top layer, a urine-impermeable base layer and at least one internal layer disposed between the top layer and the urine-impermeable base layer, wherein the at least one internal layer comprises an absorbent layer and wherein the top layer has at least one urine-repellant area; and
forming at least one urine-collection channel in the layered structure by removing at least a portion of the top layer to provide an opening in the top layer which exposes the at least one internal layer beneath the removed portion of the top layer to urine when disposed on the at least one urine-repellant area of the top layer;
wherein the at least one urine-repellant area is bordered by at least one urine-collection channel.

20. The method of forming a pet training pad, further comprising forming the at least one urine-collection channel in the layered structure by removing a portion of the at least one internal layer beneath the removed portion of the top layer.
